(19) United States
(12) Patent Application Publication
(10) Pub. No.: US 2024/0116614 A1
(43) Pub. Date: Apr. 11, 2024

(54) MODIFIED WORKBOAT AND METHOD FOR EFFICIENTLY POWERING A WORKBOAT

(71) Applicants: Christian Townsend, South Portland, ME (US); Corning Townsend, Edgecomb, ME (US)

(72) Inventors: Christian Townsend, South Portland, ME (US); Corning Townsend, Edgecomb, ME (US)

(21) Appl. No.: 18/332,733

(22) Filed: Jun. 10, 2023

Related U.S. Application Data
(60) Provisional application No. 63/351,328, filed on Jun. 10, 2022.

(51) Int. Cl. B63H 21/00; B60L 50/60; B63B 35/66; B63H 21/22

(52) U.S. Cl. CPC B63H 21/00; B60L 50/66; B63B 35/66; B63H 21/22; B60L 2200/32

(57) ABSTRACT

A modular configuration of a workboat including a main deck. The workboat includes an engine operators station including one or more variable frequency drives and one or more switchboards to manage propulsion of the workboat. The workboat also includes one or more battery sets, wherein each of the one or more battery sets includes a plurality of batteries contained in a battery set container, wherein at least one of the one or more battery sets is coupled to one or more systems of the workboat that require energy. The battery set containers may be moved using a rail structure of the workboat below the main deck. The one or more battery set containers may be moved back and forth below the main deck for transfer in and out of the workboat.

### BACKGROUND OF THE INVENTION

### 1. Field of the Invention

The present invention relates to the modular design of a workboat. More particularly, the present invention relates to a modified workboat design and a related method of powering the workboat with a replaceable power supply, such as batteries but not limited thereto, by efficient modular power source configuration and placement in the new workboat configuration. The present invention is effective in powering workboats such as towboats, tugboats, and other similar types of workboats with an alternative to fossil fuels.

### 2. Description of the Prior Art

A workboat, which may be a towboat, a tugboat, or a pushboat, for example, is critical to the movement of goods on waterways. The workboat is generally arranged to move barges from one location to another on a waterway. The loads moved by a workboat can be very large and they travel great distances. The Mississippi River is one example of a waterway used to transport large quantities of goods long distances employing workboats to enable that movement. A typical barge may carry 1500 tons of cargo, the workboat may push up to 50 such barges for hundreds of miles. These waterway cargo transport systems are critical commerce infrastructure elements.

Workboats have largely been powered solely by diesel engines and diesel-powered generators. More recently, efforts to reduce reliance on fossil fuels for a variety of reasons have focused attention on electric power sourced from batteries to power workboats.

Many workboat designers around the world are struggling to launch electric workboats. The electric, supply is currently a set of batteries. There are several problems with existing battery arrangements. First, the workboat can only run a few hours before charging is necessary with existing battery systems suitable for use. Second, the workboat is “loose packed” with batteries, much like the battery packs employed with electric cars. There is no containment of the batteries, rather they are placed individually where there is room available on the workboat. That leads to hazardous conditions on the workboat in addition to being inefficient in use of valuable space on the boat. In addition, battery usage is inefficient due to the loose packing and, therefore, a reduction in the number of batteries than can be deployed. Third, as a result of limited space for battery storage under existing workboat designs, it is necessary for the workboat to return to dock often to charge at a very high amperage rate the loosely packed batteries, which is expensive and reduces the life of the battery set.

Another limitation of current workboat design is the installation and placement of the operations station of the workboat. The operations station, which may be referred to as the Engine Operators Station (“EOS”), is a console system designed to enable operation of the workboat, including control of power supply to subsystems of the workboat. The EOS is an important component of the workboat, but it can be damaged on installation and can be difficult to access for maintenance and/or modification. Further, in existing construction processes, the EOS is ordinarily installed below deck during vessel fabrication. That makes it difficult to access upon vessel completion and near impossible to modify in the future. It would be better to have easier access to the EOS and to limit the inefficiency of vessel fabrication associated with piecemeal installation of the EOS.

What is needed is a battery storage arrangement on a workboat that avoids the limitations associated with loose packing. What is also needed is a system of battery storage insertion and removal that reduces the time for battery placement and replacement. Further, what is needed is an improved installation and placement arrangement for the EOS.

### SUMMARY OF THE INVENTION

It is an object of the present invention to provide a battery storage arrangement on a workboat that avoids the limitations associated with loose packing. It is also an object of the invention to provide a system of battery storage insertion and removal that reduces the time for battery placement and replacement. Further, it is an object of the invention to provide an improved installation and placement arrangement for the EOS, including an arrangement that integrates effectively with the improved battery storage arrangement of the invention.

The present invention is a modular system of components arranged to control workboat operation and to enable effective powering of the workboat. The EOS of the invention is a module containing one or more variable frequency drives and one or more switchboards for the workboat operator to manage the propulsion system. The EOS may be much like existing operation stations but is substantially fabricated offsite and then installed on the deck of the workboat near completion of the workboat fabrication. This minimizes potential damage to the EOS. The EOS includes a plurality of couplings including, but not limited to, coupling to propulsion and to power. The EOS in modular form may be more easily maintained and replaced based on its location on deck rather than below deck and its modular configuration with readily accessible couplings arranged for ease of disconnect and connection. In addition, the EOS in its modular form may be located below deck.

The invention also includes one or more modular battery sets. A plurality of batteries suitable for workboat powering are removably contained in a battery set container. One or more battery set containers may be deployed on the workboat. Each battery set container is coupled to one or more systems of the workboat that require energy. The batteries may be coupled directly to such systems or through the EOS. The EOS is arranged to control power supply from the batteries. The battery sets in the battery set container, as well as the container itself, may be any suitably arranged to power systems of interest on the workboat. The modular battery sets available from the Shift Company of Vancouver, British Columbia, Canada, are suitable for the battery sets of the present invention.

The invention further includes a workboat design that includes placement of the EOS, placement of the one or more battery set containers, and arrangements for easy insertion and removal of the one or more battery set containers. The EDS is located aft on the main deck of the workboat in an embodiment of the invention. That placement may occur substantially after much of the workboat has been constructed, including any refurbishment of an existing workboat. The EOS located aft on the deck includes couplings for control and powering of operational systems of the workboat including the power source, engine, and propulsion. The one or more battery set containers are positioned midship or forward below deck in a hold and include coupling directly or indirectly to the EOS. Placing the one or more battery set containers midship or forward makes for easier access thereto. At least a portion of the one or more battery set containers may be placed in locations other than the hold including, but not limited to, on the main deck.

The workboat design includes a load cell or rail structure below deck on which at least one of the one or more battery set containers may be robotically placed. The at least one of the battery set containers includes wheels or other means for engaging the rails to allow for ease of movement of such battery set containers aft to allow for placement of other battery set containers, and forward for ease of movement of the container out of the workboat hold. The workboat design further includes a hatch midship or forward and arranged to enable placement of the one or more battery set containers in the hold, and removal therefrom. The battery set containers will be located down to the workboat once the final battery operating location is established. The loading and unloading of the battery sets can be an automated process so that workboat crew members are positioned away from hazardous conditions during the process, such as when lowering, lifting, and/or transferring within the workboat or when locking down the one or more battery set containers on the workboat.

The modular arrangement of the batteries provided by use of the battery set containers rather than loosely-packed batteries result in the ability to deliver battery packs to the workboat while the workboat is underway. The same is done with food, fuel, removing sewage, delivering water, etc. The modular battery set containers may be swapped out using a land-based crane, or on the water with a barge and a crane so that the workboat can remain in transit while re-charging with one or more fully charged replacement battery sets. The workboat may pull over to the side of the river for a relatively brief period of time for battery swap. It could also be done while the workboat remains underway. That highly efficient mechanism to keep the workboat powered at all times is simply not possible with existing ad hoc, haphazardous loose battery pack.

The use of land-based and/or barge-based terminals with the modular workboat configuration of the invention enable the charging, maintenance, and storage of battery sets for routine swapping or maintenance related emergency swapping so that the workboat can continue to operate with little downtime. In addition, battery sets can be staged along river systems while monitoring the health of the battery sets onboard the workboat in real time and convey information to the workboat as to when and where a battery set should be replaced, thus allowing for line haul travel rather than just harbor, ferry or short run work. While the invention described herein is for a workboat, it is to be noted that such a modular configuration with the components described may be part of the design of any watercraft.

The EOS, one or more battery sets, and workboat design reduces construction and battery, charging delays. Beyond that, the modular design of the workboat, while described herein primarily with respect to the EOS and battery set containers, is not limited to those components of the modular workboat construct. For example, other components as well as other forms of the EOS and power supply, such as fuel cells and the like, may be provided in modular form consistent with the invention as described. These and other advantages of the invention will become further apparent upon review of the detailed description and accompanying drawings.

### BRIEF DESCRIPTION OF THE DRAWINGS

FIG. 1 is an elevation view of the workboat of the present invention with EOS, two representative battery set containers installed and a third battery set container in transit,

FIG. 2 is a plan view of the workboat of FIG. 1 showing one of the battery set containers.

FIG. 3 is a plan view of the workboat of FIG. 1 showing electrical couplings between the EOS and propulsion units, and between the EOS and the battery sets.

FIG. 4 is a plan view of the workboat of FIG. 1 showing the battery sets located below deck.

FIG. 5 is a plan view of a portion of the deck of the workboat of FIG. 1 showing the hatch through which the battery set containers are passed into the hold.

FIG. 6 is an elevation view of the workboat of FIG. 1 showing the lowering of the EOS onto a deck platform and insertion of a battery set container through a hatch into a hold.

FIG. 7 is a first rear perspective view of an embodiment of the workboat of the present invention.

FIG. 8 is a second rear perspective view of the embodiment of the workboat of FIG. 7.

FIG. 9 is a rear view of the embodiment of the workboat of FIG. 7,

FIG. 10 is a port side view of the embodiment of the workboat of FIG. 7.

FIG. 11 is a partial rear perspective view of the embodiment of the workboat of FIG. 7 showing in part the EOS on the main deck below the upper deck.

### DETAILED DESCRIPTION OF THE INVENTION

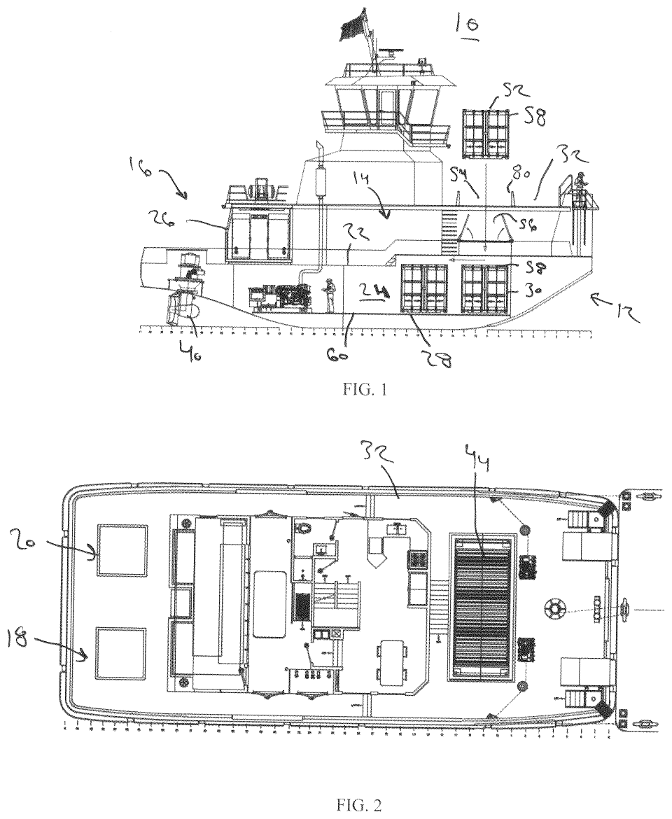

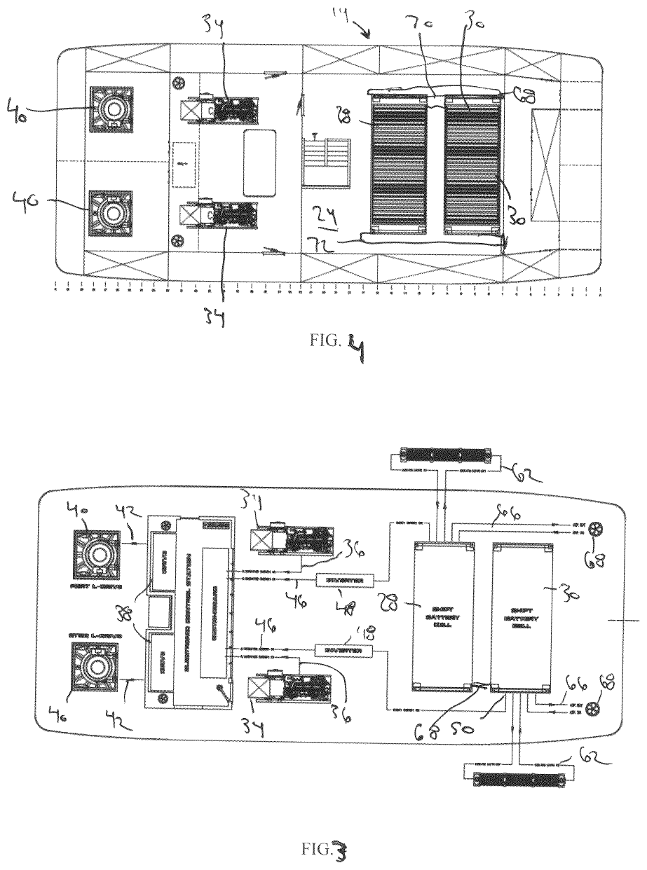

A workboat 10 of the present invention is shown in FIGS. 1-7. The workboat 10 includes a fore section 12, a midship section 14, an aft section 16, a port side 18, and a starboard side 20, all of which sections are conventional for any watercraft. The workboat 10 further includes a main deck 22 and a hold 24 below the main deck 22. The workboat 10 includes an Electronic Operators Station (FOS) 26 in the aft section 14 on the main deck 22, and a first battery set container 28 and a second battery set container 30 in the fore section 12 of the hold 24. The workboat 10 also includes an upper deck 32. While the invention is described herein with respect to the workboat 10 being a new construction including the EOS 26 and the battery set containers, it is to be understood that the EOS 26 and/or the battery set containers may form part of a workboat that has been refurbished to include the configuration of modular components described herein.

In the embodiment of the invention shown in the figures, the EOS 26 is positioned on the main deck 22 and removably secured thereto. The EOS 26 is installed on the workboat 26 after substantially the entire workboat 10 has been fabricated rather than built integrally over time with fabrication of the workboat 26. In that way, the EDS 26 of the present invention is modular and, as a result, easier to replace much more rapidly in the event of a maintenance requirement, for example. It is to be noted that the EOS 26 may also be positioned in other locations on the workboat 10.

The EOS 26 includes one or more variable frequency drives electrically coupled to one or more electronic motors 34 via cables 36. The EOS 26 also includes one or more switchboards 38 for controlling all components of propulsion, including one or more propulsors 40 via couplings 42. The EOS 26 is also coupled to battery cells 44 of one or more battery sets including battery cells 44 of the first battery set container 28 and the second battery set container 30 via supply cables 46. An inverter 48 is used to convert DC power from the battery cells 44 to AC power at the EOS 26. The inverter 48 is shown in FIG. 3 spaced from the EOS 26 but it may be an integral part of the EOS 26. The EOS 26 is coupled to the battery cells 44 of the one or more battery sets after both are installed on the workboat 10. All battery set containers including the battery set containers 28 and 30 have quick-connect fittings 50 for ease of connect and disconnect to the EOS 26, such as when one or more battery sets are quickly replaced.

Each of the one or more battery set containers including the first battery set container 28 and the second battery set container 30 includes a selectable number of battery cells 44. The battery cells 44 are coupled together in series. The containers may be fabricated offsite and transferred to the workboat 10 for rapid installation. FIG. 1 shows a third battery set container 52 in transit into the workboat hold 24 through upper deck hatch 54 of the upper deck 32 and through main deck hatch 56 of the main deck 22. The battery set containers may be available from a company named Shift but not limited thereto.

Containers 58 of the battery set containers are waterproof, of sufficient structural integrity to withstand anticipated conditions experienced on a workboat and are removably secured to hold deck 60. Each of hatches 54 and 56 may have one or two doors to cover the hatch holes while the workboat 10 is operating. The doors may be installed above deck level to form a raised hatch that minimizes water transfer into the hold 24. A safety wall 80 may be deployed on the upper deck 32 about the upper deck hatch 54 to prevent accidents. While the battery set containers are shown located in the hold 24, it is to be understood that some or all of them may be located in different locations including, but not limited to, on the main deck 22.

Each of the containers 58 includes a connection through the supply cable 46 to the EOS 26, a connection through coolant tubing 62 to chiller 64, and a connection through vent tubing 66 to ventilation such as fan 68. Coolant from the chiller 64 is used to maintain the temperature of the battery cells 44 at a selectable temperature chosen to maximize battery operation efficiency. The fan 68 is used to vent air within the container 58 to disperse any hazardous off-gassing that may occur from battery operation. The connections of the container 58 are watertight. The modular configuration of the power supply for the workboat 10 embodied in the battery set containers enables rapid removal and insertion of the power source for the workboat 10 much more efficiently than occurs for the piecemeal loose packing that existed prior to the present invention.

The workboat 10 further includes a rail system 68 removably affixed to hold deck 60 amidship. The rail system 68 includes a first rail 70 and a second rail 72 spaced and configured to hold and move the one or more battery set containers. The first rail 70 and the second rail 72 are of sufficient length to enable movement of the battery set containers aft after they have bene lowered through the main deck hatch 56 into the hold 24. In that way, a plurality of battery set containers may be installed in the hold 24 and removed therefrom quickly as an aspect of the modular system of the design of the workboat 10. FIGS. 3 and 4 show the first battery set container 28 and the second batter set container 30 adjacent to one another after the first battery set container 28 has been moved aft on the rail system 68. In an embodiment of the invention, one or more of the first battery set container 28 and the second battery set container 30 may be wheeled to facilitate the movement thereof on the rail system 68, a load cell, or the like. The process of movement may be automated, and an automatic tie-down system may be used to secure the battery set containers in place.

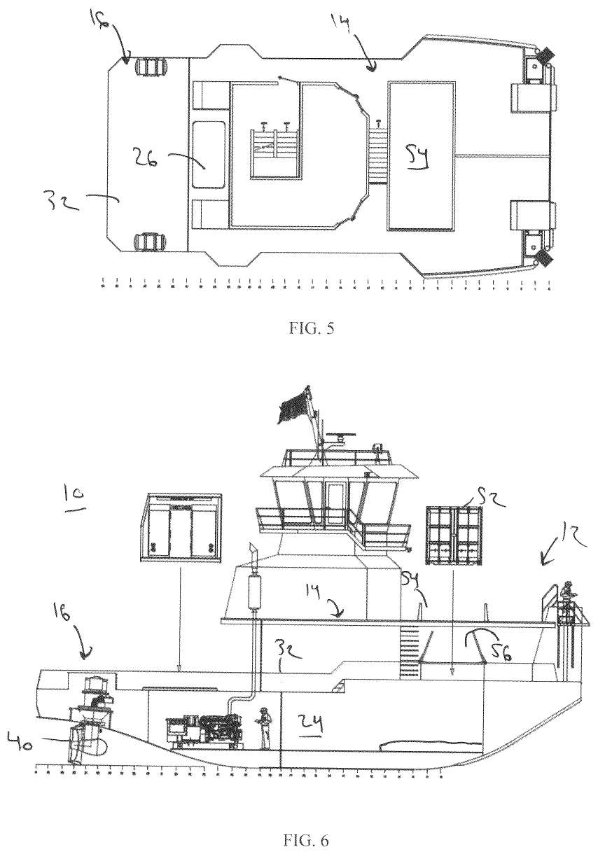

The design of the workboat 10 of the present invention with the arrangement of the FOS 26, and the configuration and placement of the one or more battery set containers is unique in the field of workboat designs. The method of configuring the workboat 10 is also unique. As represented in FIG. 6, the method includes lowering the EOS 26 onto the main deck 22 after construction of the workboat 10 is substantially completed. This reduces any chance of damage during construction when this equipment is normally buried in the workboat 10 “loose packed”. The EOS 26 is bolted to the main deck 22 in the aft section 16. A guide system may be deployed so that any bouncing about of a battery container set during passage into the hold 24 will not cause placement difficulty or battery damage.

The battery set containers may be loaded into the workboat 10 through hatches 54 and 56 at the beginning of a work shift and then additional ones may be inserted or existing ones removed and replaced at a later shift. This eliminates the need to quick charge the batteries as there can be several battery set containers on shore charging more conventionally. This increases the number of charges in the battery life from about 3000 to about 15000 charges. Battery packs can also be swapped out in about thirty minutes with a full charge rather than doing a quick charge at shift change, which only charges the batteries to about 60-75% in thirty minutes. The reduced amperage when charging allows for 15000 charges and so may be about five times less expensive in terms of battery wear. Benefits of the present invention include quick turn-around for full charge and the limited number of batteries aboard to complete the workboat's service obligation.

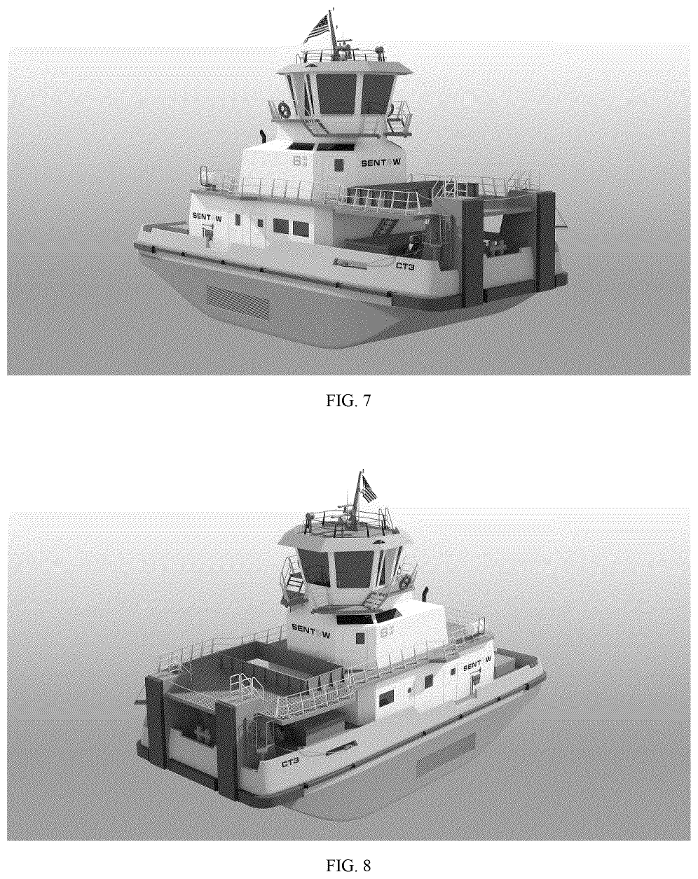

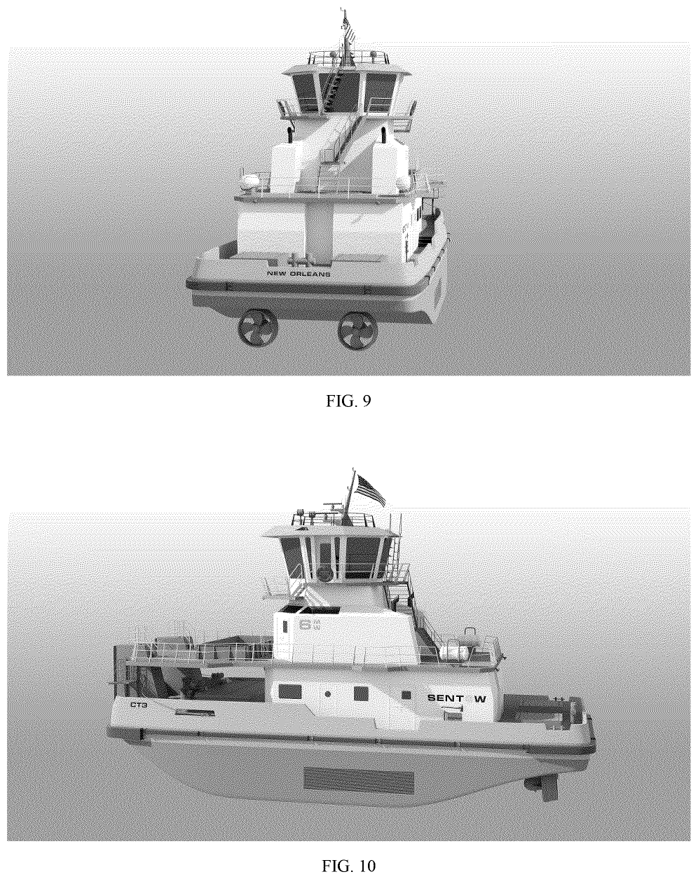

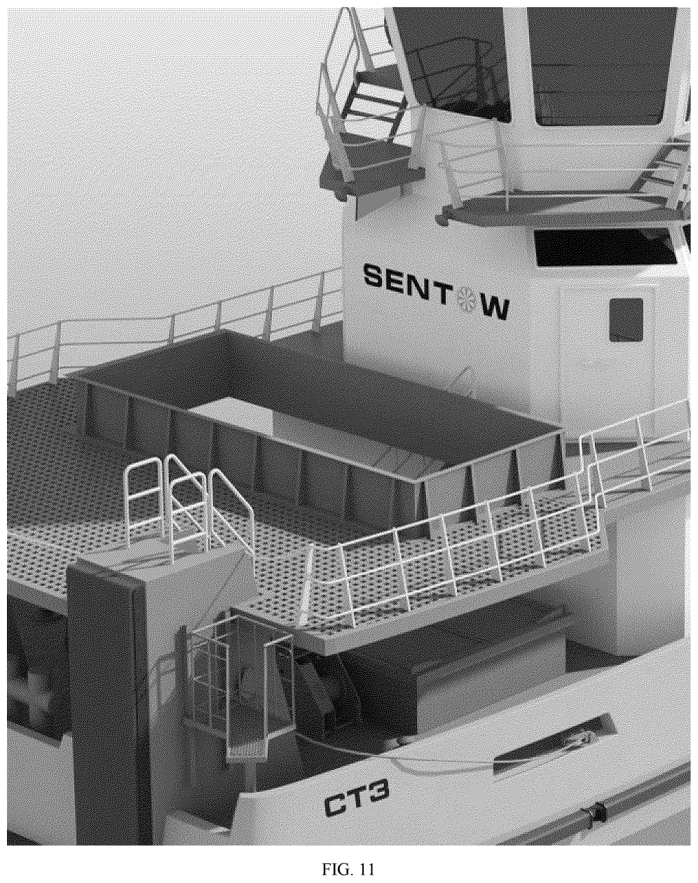

FIGS. 7-11 show an example embodiment of the workboat of the present invention including the modular configuration of at least the EOS and the battery set containers. The workboat of FIGS. 7-11 is designed to enable rapid swapping out of battery set containers and other modular components when the workboat is at the dock, anchored in the waterway or underway.

What is claimed is:

1. A workboat including a main deck, the workboat comprising:
an engine operators station including one or more variable frequency drives and one or more switchboards to manage propulsion of the workboat;
one or more battery sets, wherein each of the one or more battery sets includes a plurality of batteries contained in a battery set container, wherein at least one of the one or more battery sets is coupled to one or more systems of the workboat that require energy; and
a rail structure below the main deck on which at least one of the one or more battery set containers may be placed, wherein the one or more battery set containers may be moved back and forth below the main deck for transfer in and out of the workboat.

2. The workboat of claim 1, wherein the engine operators station is located below the main deck.

3. The workboat of claim 1, wherein the at least one of the one or more battery sets is coupled to the one or more systems of the workboat through the engine operators system.

4. The workboat of claim 1, wherein the engine operators station is located aft on the main deck.

5. The workboat of claim 1, wherein one or more battery set containers are located midship on the workboat.

6. The workboat of claim 1, wherein one or more battery set containers are located forward on the workboat in a hold below the main deck.

7. The workboat of claim 6, further comprising a hatch midship or forward and arranged to enable placement of the one or more battery set containers in the hold, and removal therefrom.
